(19) United States
(12) Patent Application Publication
(10) Pub. No.: US 2013/0275411 A1
(43) Pub. Date: Oct. 17, 2013

(54) IMAGE SEARCH METHOD AND DIGITAL DEVICE FOR THE SAME

(71) Applicant: LG ELECTRONICS INC., Seoul (KR)

(72) Inventors: Hosoo KIM, Seoul (KR); Eulina KO, Seoul (KR); Chaesung LEEM, Seoul (KR)

(73) Assignee: LG ELECTRONICS INC., Seoul (KR)

(21) Appl. No.: 13/672,471

(22) Filed: Nov. 8, 2012

Related U.S. Application Data
(60) Provisional application No. 61/623,580, filed on Apr. 13, 2012.

(30) Foreign Application Priority Data
Aug. 13, 2012 (KR) 10-2012-0088234

(51) Int. Cl. G06F 17/30; G06F 3/0484

(52) U.S. Cl. CPC G06F 17/30277; G06F 3/04842
USPC 707/722

(57) ABSTRACT

An Intelligent Agent (IA) application, which extracts an image object from content displayed by the other application and provides a search result of the image object, and an image search method using the same are disclosed. The image search method includes executing a first application that displays content including at least one image object, driving a second application that provides an image search result of the image object included in the content displayed by the first application, extracting the at least one image object from the content via the second application, providing, on top of the first application, at least one object interface corresponding to the at least one extracted image object via the second application, receiving a user input of selecting a particular object interface among the at least one object interface, and displaying a search result of the image object corresponding to the particular object interface.

This application claims the benefit of Korean Patent Application No. 10-2012-0088234, filed on Aug. 13, 2012 and U.S. Provisional patent application No. 61/623,580 filed on Apr. 13, 2012 which are hereby incorporated by reference as if fully set forth herein.

### BACKGROUND OF THE INVENTION

1. Field of the Invention

The present invention relates to an image search method and a digital device for the same, and more particularly to an Intelligent Agent (IA) application, which extracts an image object from content displayed by the other application and provides a search result of the image object, and an image search method using the same.

2. Discussion of the Related Art

Multimedia content of today includes various forms of digital content in which text, image, audio and video data, and the like are combined. A good percentage of such digital content includes image data, and the image data may be displayed via a display unit of a digital device. With the progress of multimedia technologies, the frequency of a user utilizing content having image data other than traditional content including only text data is gradually increasing. However, the user has often experienced inconvenience to receive information associated with image data from the multimedia content. For example, when attempting to acquire information associated with a particular object of image data, the user must inconveniently search a keyword with respect to the corresponding object separately, or input the keyword.

To eliminate the aforementioned inconvenience, a variety of applications for image search have been developed. Image search refers to a technology for searching information corresponding to an objective image, differently from traditional keyword search for searching information corresponding to a keyword in the form of text. Image search applications are capable of analyzing a search objective image and providing search results of images similar to the objective image. Moreover, these image search applications are capable of searching and providing information associated with the search objective image.

Meanwhile, diversification in the kind and form of digital content causes use of various applications for execution of corresponding digital content. Accordingly, the user has a need for an intuitive and simple method capable of receiving digital content via various applications and searching image data included in the corresponding digital content.

### SUMMARY OF THE INVENTION

Accordingly, the present invention is directed to an image search method and a digital device for the same that substantially obviate one or more problems due to limitations and disadvantages of the related art.

One object of the present invention is to provide a method for performing image object based search, thereby assisting a user in easily receiving information associated with image data included in digital content.

In particular, another object of the present invention is to provide an intuitive user interface capable of assisting a user in easily accessing information associated with image data included in digital content even when the user executes the corresponding digital content via various applications.

Another object of the present invention is to provide a user interface capable of assisting a user in simply selecting an image object for search from among a plurality of image objects included in image data.

A further object of the present invention is to provide a user interface capable of assisting a user in easily recognizing an image object, information on which is searchable, among a plurality of image objects included in image data.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an image search method includes executing a first application, wherein the first application displays content including at least one image object, executing a second application, wherein the second application provides an image search result of the image object included in the content displayed by the first application, extracting the at least one image object from the content displayed on the first application via the second application, providing, on top of the first application, at least one object interface corresponding to the at least one extracted image object via the second application, receiving a user input of selecting a particular object interface among the at least one object interface, and displaying a search result of the image object corresponding to the particular object interface selected by the user input.

In accordance with another aspect of the present invention, a digital device includes a processor configured to control an operation of the digital device, a communication unit configured to perform transmission/reception of data with a server based on a command of the processor, and a display unit configured to output an image based on a command of the processor, wherein the processor performs the following operations including executing a first application, wherein the first application displays content including at least one image object, executing a second application, wherein the second application provides an image search result of the image object included in the content displayed by the first application, extracting the at least one image object from the content displayed on the first application via the second application, providing, on top of the first application, at least one object interface corresponding to the at least one extracted image object via the second application, receiving a user input of selecting a particular object interface among the at least one object interface, and displaying a search result of the image object, corresponding to the particular object interface selected by the user input, on a display unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing a executed state of a first application that displays content;

FIG. 2 is a view showing a state in which an Intelligent Agent (IA) application is executed together with the first application according to an embodiment of the present invention;

FIGS. 3(a) and 3(b) are views showing a method for providing at least one object interface over the first application via the IA application;

FIG. 4 is a view showing a method for providing an object interface according to another embodiment of the present invention;

FIGS. 5 to 7 are views showing embodiments for implementation of image search with respect to image objects using the IA application according to the present invention;

FIGS. 8 to 10 are views showing other embodiments for implementation of image search with respect to image objects using the IA application according to the present invention;

FIG. 11 is a block diagram showing a configuration of a digital device according to an embodiment of the present invention;

FIG. 12 is a block diagram showing a configuration of an IA application according to an embodiment of the present invention;

FIG. 13 is a flowchart showing an image search method according to one embodiment of the present invention;

FIG. 14 is a flowchart showing an image search method according to another embodiment of the present invention; and

FIG. 15 is a flowchart showing an image search method according to a further embodiment of the present invention.

### DETAILED DESCRIPTION OF THE INVENTION

Although the terms used in the following description are selected, as much as possible, from general terms that are widely used at present while taking into consideration of the functions obtained in accordance with the present invention, these terms may be replaced by other terms based on intensions of those skilled in the art, customs, emergence of new technologies, or the like. Also, in a particular case, terms that are arbitrarily selected by the applicant of the present invention may be used. In this case, the meanings of these terms may be described in corresponding description parts of the invention. Accordingly, it should be noted that the terms used herein should be construed based on practical meanings thereof and the whole content of this specification, rather than being simply construed based on names of the terms.

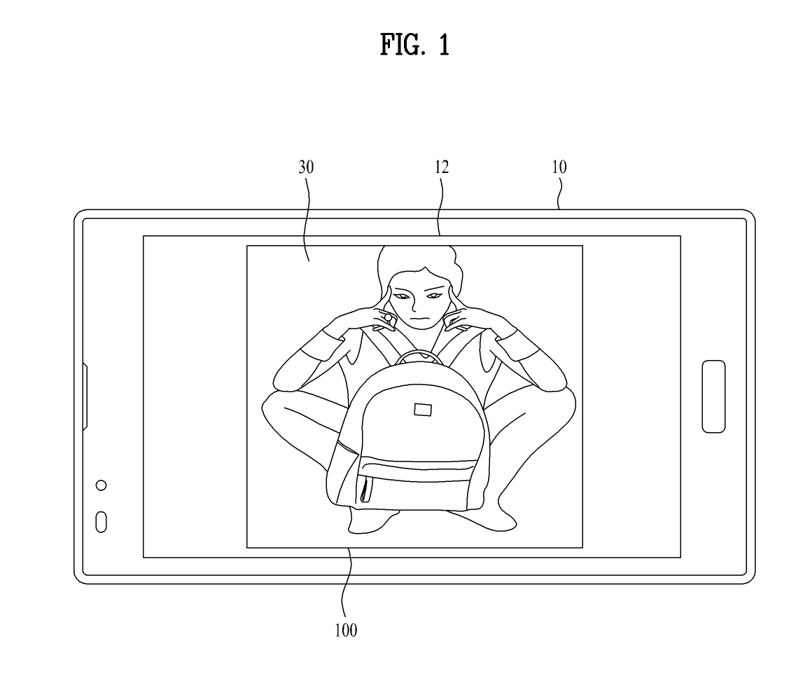

FIG. 1 is a view showing a executed state of a first application 100 that displays content 30. The first application 100 may be driven by a digital device 10 and may execute the content 30 including image data. A display unit 12 of the digital device 10 may display image data of the content 30 executed by the first application 100. In the present invention, the content 30 is executed by the first application 100, and may include at least one image object displayed on a display unit 12.

In the present invention, the first application 100 includes a variety of applications capable of executing the content 30 including image data. For example, the first application 100 may include an image viewer, an image editor, a video player, a video editor, a web browser, and a text editor, for example. However, the present invention is not limited thereto, and includes various other applications capable of outputting image data included in the content 30 from the display unit 12 of the digital device 10.

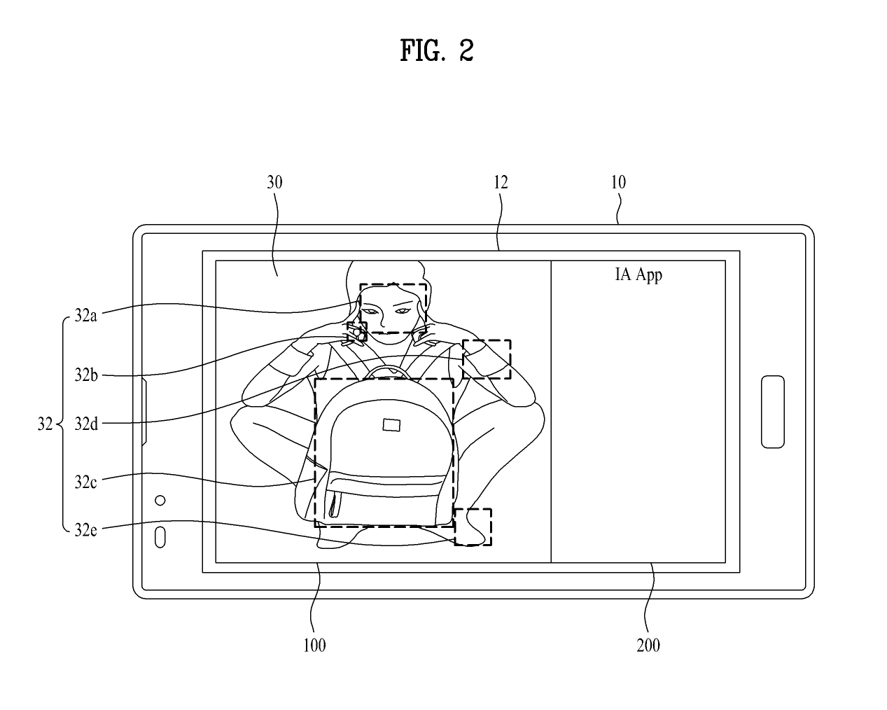

FIG. 2 is a view showing a executed state of an Intelligent Agent (IA) application 200 according to an embodiment of the present invention. The IA application 200 serves to provide search results of image objects 32 included in the content 30 that is displayed by the first application 100. The IA application 200 may driven by the digital device 10. More specifically, the IA application 200 may extract at least one image object 32 from the content 30 that is being displayed by the first application 100, and may provide search results of the corresponding image object 32. Various other embodiments in relation to a method for executing the IA application 200 on the digital device 10 are possible. For example, the digital device 10 may execute the IA application 200 in response to a user input of dragging the image object 32 from a rim region to a center region of the display unit 12, a user input of touching a button to call the IA application 200, or an audio input to call the IA application 200, for example, although the present invention is not limited thereto. In the embodiment of the present invention, the IA application 200 may be a second application different from the first application 100.

According to the embodiment of the present invention, the IA application 200 and the first application 100 may simultaneously be in an activated state on the digital device 10. In the present invention, the activated state of an application refers to a state in which the corresponding application is in a foreground process state on the digital device 10. The activated application may directly receive a user input and perform a corresponding operation on the digital device 10. On the other hand, if the activated application is switched to an inactivated state, the corresponding application may stop a current operation, or may continue an operation thereof in a background process state. Again switching the inactivated application to an activated state is required to perform a user input on the corresponding application.

In the embodiment of the present invention, if the IA application 200 and the first application 100 are simultaneously in an activated state, both the IA application 200 and the first application 100 are in a foreground process state on the digital device 10. Thus, the IA application 200 and the first application 100 are capable of directly receiving a user input, and at least one of the IA application 200 and the first application 100 that has received the user input will perform an operation corresponding to the user input. For example, if a user input, such as touch input, is performed on the IA application 200 displayed on the display unit 12, the digital device 10 may enable implementation of an operation of the IA application 200 corresponding to the user input. Also, if a user input, such as touch input, is performed on the first application 100 displayed on the display unit 12, the digital device 10 may enable implementation of an operation of the first application 100 corresponding to the user input. According to an alternative embodiment of the present invention, the digital device 10 may receive a multi-touch user input of touching and operating the IA application 200 and the first application 100 simultaneously on the display unit 12. In this case, the digital device 10 may enable simultaneously implementation of operations of the IA application 200 and the first application 100 in response to the user input.

According to the embodiment of the present invention, the digital device 10 may display the IA application 200 and the first application 100 together on the display unit 12. More specifically, the digital device 10 may display the first application 100 on a partial region of the display unit 12, and may display the IA application 200 on the remaining region of the display unit 12. Alternatively, the digital device 10 may display the IA application 200 overlaid on a part of or the entire display region of the first application 100.

According to the embodiment of the present invention, the digital device 10 may display the IA application 200 on a region adjacent to at least one side of the first application 100. For example, if the IA application 200 is called in a state in which the first application 100 is activated as shown in FIG. 1, the digital device 10 may display the IA application 200 along with the first application 100 such that the IA application 200 is located adjacent to at least one side of the first application 100. In this case, the digital device 10 may adjust a display region of the first application 100, in order to display the first application 100 and the IA application 200 together. According to the embodiment of the present invention, the digital device 10 may allow the IA application 200 and the first application 100 to be executed in conjunction with each other like a single application.

The IA application 200 according to the embodiment of the present invention functions to extract the at least one image object 32 from the content 30 displayed by the first application 100. The image object 32 is an object, such as a particular product, person, and background, for example, in the image data, and may correspond to a partial region or the entire region within a frame of the corresponding image data. Also, the image object 32 may represent a particular region differentiable from the remaining region within the frame of the image data. The IA application 200 of the present invention may analyze an image displayed by the first application 100 via image processing, and extract the at least one image object 32 from the analyzed image. In this specification of the present invention, the image object 32, which is described as singular, may include the meaning of a plurality of image objects 32.

Next, the IA application 200 functions to generate a search keyword respectively corresponding to the at least one extracted image object 32. The search keyword may be a text form keyword used to search information corresponding to the image object 32. According to an embodiment of the present invention, the IA application 200 may utilize a database equipped in the digital device 10 to generate the search keyword. More specifically, the IA application 200 may acquire the search keyword corresponding to the extracted image object 32 by performing a keyword query using the database equipped in the digital device 10. According to an alternative embodiment of the present invention, the IA application 200 may acquire the search keyword corresponding to the image object 32 using an external server (not shown). More specifically, the IA application 200 may transmit the at least one extracted image object 32 to the external server, and receive the search keyword corresponding to the at least one image object 32 from the server.

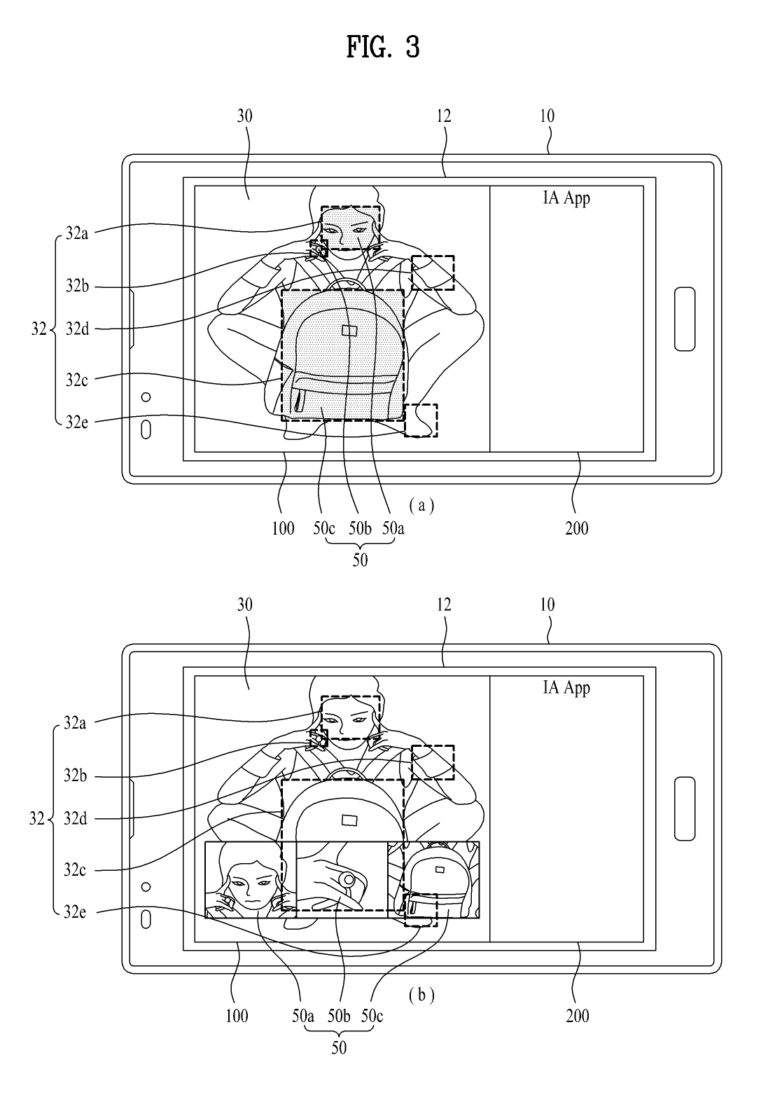

FIGS. 3(a) and 3(b) are views showing methods for providing at least one object interface 50 on the first application 100 according to different embodiments of the present invention. The object interface 50 is an interface corresponding to the image object 32 displayed by the first application 100. The object interface 50 may be provided by the IA application 200. The IA application 200 of the present invention may provide the object interface 50 on a region of the first application 100 corresponding to the corresponding image object 32.

According to one embodiment of the present invention shown in FIG. 3(a), the IA application 200 may provide the object interface 50 overlaid on the corresponding image object 32 on the first application 100. For example, the IA application 200 may display the object interface 50 so as to overlap the corresponding image object 32. According to an alternative embodiment of the present invention, the IA application 200 may not display the object interface 50 separately, but provide the activated object interface 50 on a region of the first application 100 corresponding to the image object 32. In the embodiment shown in FIG. 3(a), the IA application 200 may receive a user input of touching the image object 32 displayed by the first application 100 via the object interface 50 overlaid on the corresponding image object 32. In this way, according to the embodiment of the present invention, even if the first application 100 does not provide a separate interface for selection of each image object 32, the IA application 200 may receive a user input for selection of each image object 32 displayed by the first application 100.

Meanwhile, according to the embodiment of the present invention, assuming that the content 30 includes the plurality of image objects 32 and some or all of the image objects 32 are provided with search keywords, the IA application 200 may provide the object interface 50 corresponding to the corresponding image object 32, the search keyword of which has been generated. For example, in the embodiment shown in FIG. 3(a), the IA application 200 may extract image objects 32a, 32b, 32c, 32d and 32e from the content 30 displayed by the first application 100. The IA application 200 of the present invention also performs generation of search keywords with respect to the respective extracted image objects 32a to 32e. In this case, success or failure in the generation of search keywords may differ between the respective image objects 32a to 32e. For example, in the embodiment shown in FIG. 3(a), the IA application 200 may succeed in generating search keywords respectively corresponding to the image objects 32a, 32b and 32c, but may fail in generating search keywords respectively corresponding to the image objects 32d and 32e. The IA application 200 provide a display region of the first application 100 with object interfaces 50a, 50b and 50c that respectively correspond to the image objects 32a, 32b and 32c having the search keywords among the extracted image objects 32a to 32e. According to an alternative embodiment of the present invention, the IA application 200 may provide the object interfaces 50a, 50b and 50c corresponding respectively to the image objects 32a, 32b and 32c, the reliability of the search keywords of which exceeds a preset critical value. In this way, the IA application 200 according to the embodiment of the present invention may provide only the object interfaces 50a, 50b and 50c respectively corresponding to the searchable image objects 32a, 32b and 32c among the image objects 32a to 32e included in the content 30.

FIG. 3(b) shows a method for providing the object interface 50 according to another embodiment of the present invention. In the embodiment shown in FIG. 3(b), a detailed description related to the same or corresponding configurations as those in the embodiment of FIG. 3(a) will be omitted.

According to another embodiment of the present invention as shown in FIG. 3(b), the IA application 200 may display the object interface 50 at a preset region on the first application 100. For example, the IA application 200 may display the object interface 50 at a preset partial region allotted to the entire display region of the first application 100. If a plurality of object interfaces 50 is present, as shown in FIG. 3(b), the IA application 200 may display the plurality of object interfaces 50 in a list form on the preset region. According to one alternative embodiment of the present invention, the IA application 200 may display the object interfaces 50 at a partial region of the entire display region of the first application 100 so as not to overlap with the image objects 32. Also, according to another alternative embodiment of the present invention, the IA application 200 may display the object interfaces 50 corresponding to the respective image objects 32 on the display region of the IA application 200. In the embodiment shown in FIG. 3(b), the IA application 200 may provide the object interfaces 50a, 50b and 50c corresponding to the respective image objects 32a, 32b and 32c, the search keywords of which have been generated, among all the image objects 32a, 32b, 32c, 32d and 32e included in the content 30. This has been described above with reference to FIG. 3(a).

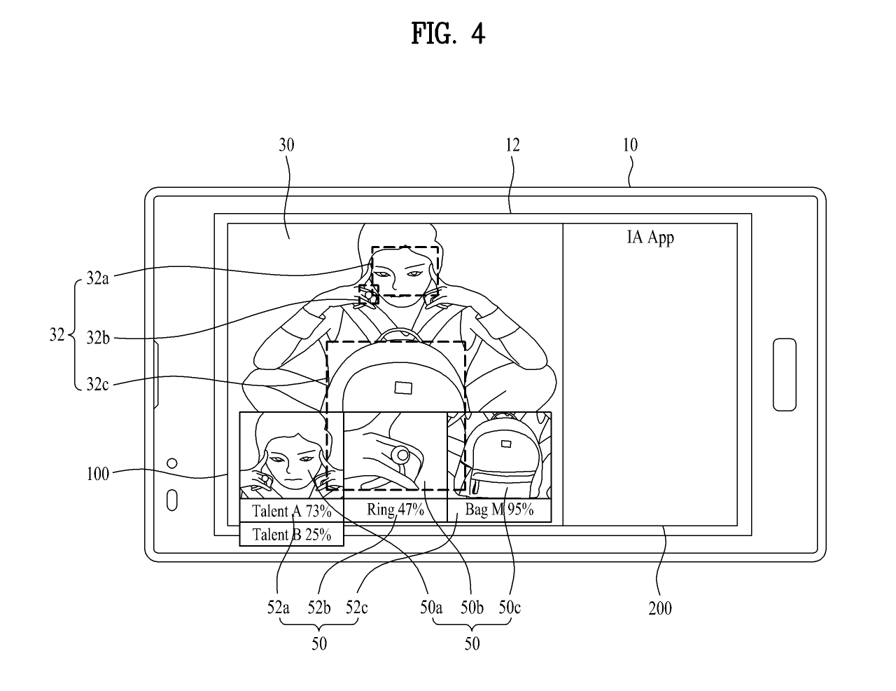

Hereinafter, image search methods of the present invention will be described with reference to FIGS. 4 to 10. These image search methods may be appropriately replaced with the method for providing the object interface 50 shown in FIG. 3(a) or FIG. 3(b).

FIG. 4 shows a further embodiment of the present invention. Referring to FIG. 4, the IA application 200 may display search keywords 52 along with the object interfaces 50, the search keywords 52 being generated to correspond to the respective image objects 32. In addition, the IA application 200 may display a reliability value of the each search keyword 52 along with the corresponding search keyword 52. In this case, the reliability value of the search keyword indicates a matching rate between the search keyword 52 and the corresponding image object 50. The IA application 200 according to the embodiment of the present invention may display each search keyword 52 and the reliability value of the search keyword 52 on a region corresponding to the corresponding object interface 50 on the first application 100. Also, the IA application 200 may adjust display properties of the search keywords 52 and reliability values. That is, the IA application 200 may adjust, for example, display positions, text scales, and text colors of the search keywords 52 and reliability values.

More specifically, in FIG. 4, the IA application 200 may generate search keywords ‘Talent A’ and ‘Talent B’, designated by reference numeral 52a, with respect to the corresponding image object 32a. In this case, the image object 32a may have the matching rate of 73% with pre-stored image data associated with the keyword ‘Talent A’, and may have the matching rate of 25% with pre-stored image data associated with the keyword ‘Talent B’. As such, with respect to the image object 32a, the reliability of the search keyword ‘Talent A’ is 73% and the reliability of the search keyword ‘Talent B’ is 25%. The IA application 200 may display the resulting search keywords 52a (i.e. the keywords ‘Talent A’ and ‘Talent B’) on a region corresponding to the object interface 50a. In this case, the IA application 200 may display the search keywords 52a along with the reliability of the corresponding search keywords 52a. Also, the IA application 200 may display a search keyword 52b (i.e. the keyword ‘Ring’) generated with respect to the image object 32b and the reliability of the search keyword 52b on a region corresponding to the object interface 50b, and may display a search keyword 52c (i.e. the keyword ‘Bag M’) generated with respect to the image object 32c and the reliability of the search keyword 52c on a region corresponding to the object interface 50c.

In the embodiment of the present invention, if the plurality of search keywords 52a is generated with respect to the single image object 32a, the IA application 200 may display the plurality of search keywords 52a together. That is, the IA application 200 may display both the search keywords ‘Talent A’ and ‘Talent B’ generated with respect to the image object 32a on a region corresponding to the object interface 50a. In this case, the IA application 200 may align and display the plurality of search keywords 52a in the reliability order of the respective search keywords 52a. Also, the IA application 200 may provide a separate user interface to assist the user in selecting any one of the plurality of search keywords 52a in response to a user input of selecting the corresponding object interface 50a.

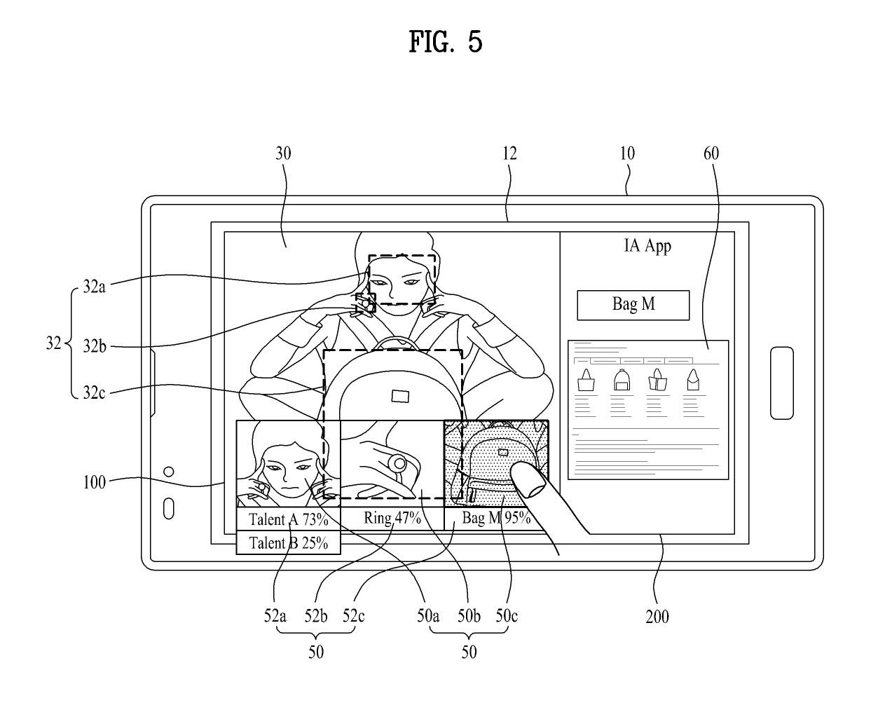

FIGS. 5 to 7 are views showing embodiments for implementation of image search with respect to the image objects using the IA application 200 according to the present invention.

First, referring to the embodiment shown in FIG. 5, the IA application 200 may receive a user input of selecting a particular object interface among one or more object interfaces 50 provided on the first application 100. For example, as shown in FIG. 5, the user may perform a user input of selecting the object interface 50c among the object interfaces 50a, 50b and 50c provided by the IA application 200. In this case, the user input of selecting the object interface 50c may be, for example, a touch input with respect to the object interface 50c, and a user input of dragging the object interface 50c and dropping the same on the display region of the IA application 200, although the present invention is not limited thereto.

Once the object interface 50c has been selected as described above, the IA application 200 performs image search with respect to the image object 32c corresponding to the object interface 50c. That is, the IA application 200 may transmit the search keyword 52c (i.e., the keyword ‘Bag M’) of the image object 32c to the server via a communication unit (not shown) of the digital device 10. The server performs search with respect to the received search keyword 52c (i.e. the keyword ‘Bag M’), and transmits a search result to the digital device 10. The digital device 10 may receive the search result 60 from the server, and the IA application 200 may display the received search result 60 on the display unit 12. As such, the user may receive the search result 60 of the keyword ‘Bag M’ with respect to the image object 32c included in the content 30.

In this case, the IA application 200 may provide the search result 60 within the display region of the IA application 200. Also, the IA application 200 may provide the search result 60 in the form of a web browser. The user may additionally perform web search on the web browser of the IA application 200 that provides the search result 60. Meanwhile, a method for providing the search result 60 may be differently adjusted according to previously studied user patterns. For example, the IA application 200 may adjust, for example, formation of categories of the search result 60 and the priority of the categories with reference to previously studied user preference. As such, according to the embodiment of the present invention, the user may perform image search of the image object 32 displayed by the first application 100 via a user input of selecting the object interface 50 provided by the IA application 200.

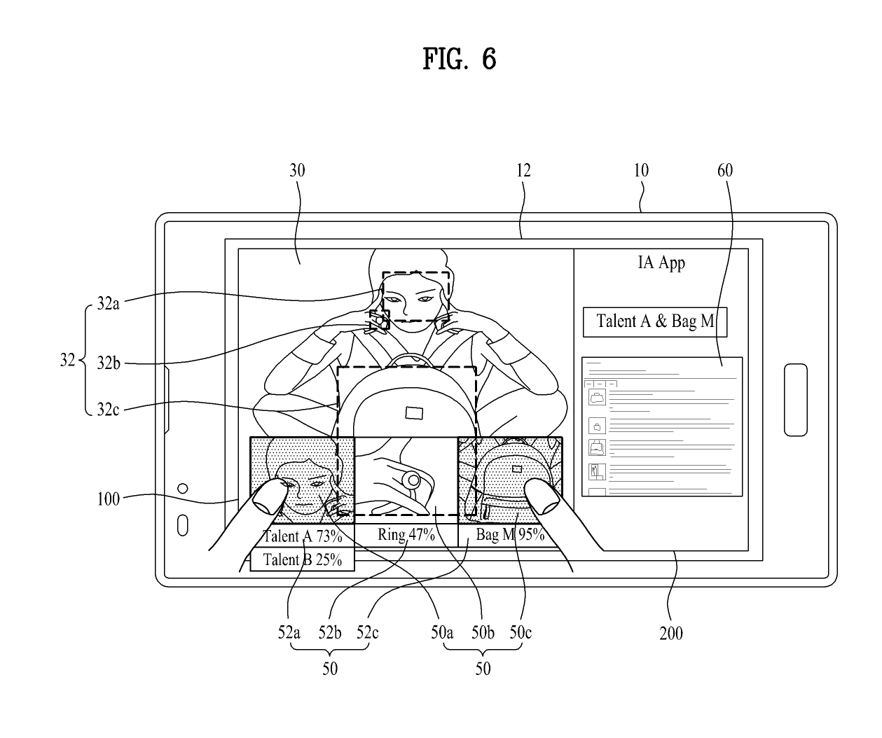

Next, referring to the embodiment shown in FIG. 6, the IA application 200 may receive a user input of selecting a plurality of object interfaces. For example, as shown in FIG. 6, the user may perform a user input of selecting the object interfaces 50a and 50c among the object interfaces 50a, 50b and 50c provided by the IA application 200. In this case, the user input of selecting the object interfaces 50a and 50c may be, for example, a multi-touch input with respect to the object interfaces 50a and 50c and a user input of simultaneously or sequentially dragging the object interfaces 50a and 50c and dropping the same on the display region of the IA application 200, although the present invention is not limited thereto.

Once the object interfaces 50a and 50c have been selected as described above, the IA application 200 performs search of a combined image of the image objects 32a and 32c respectively corresponding to the object interfaces 50a and 50c. To this end, the IA application 200 generates a combined keyword ‘Talent A’ & ‘Bag M’ by combining the search keyword 52a (i.e. the keyword ‘Talent A’) corresponding to the image object 32a and the search keyword 52c (i.e. the keyword ‘Bag M’) corresponding to the image object 32c. The combined keyword is a combination of a plurality of search keywords, and various embodiments of combining a plurality of search keywords are known. Next, the IA application 200 may transmit the combined keyword ‘Talent A’ & ‘Bag M’ to the server via the communication unit (not shown) of the digital device 10. The server performs search with respect to the combined keyword ‘Talent A’ & ‘Bag M’, and transmits the search result 60 to the digital device 10. The digital device 10 may receive the search result 60 from the server, and the IA application 200 may display the received search result 60 on the display unit 12. As such, the user may receive the search result 60 with respect to the combined search result of the image objects 32a and 32c included in the content 30, i.e. the search result 60 with respect to the combined keyword ‘Talent A’ & ‘Bag M’. For example, the combined search result 60 may include a picture that Talent A is carrying Bag M, and advertisement content of Bag M in which Talent A participates.

The IA application 200 of the present invention may provide the search result 60 within the display region of the IA application 200. A detailed embodiment thereof has been described above with reference to FIG. 5.

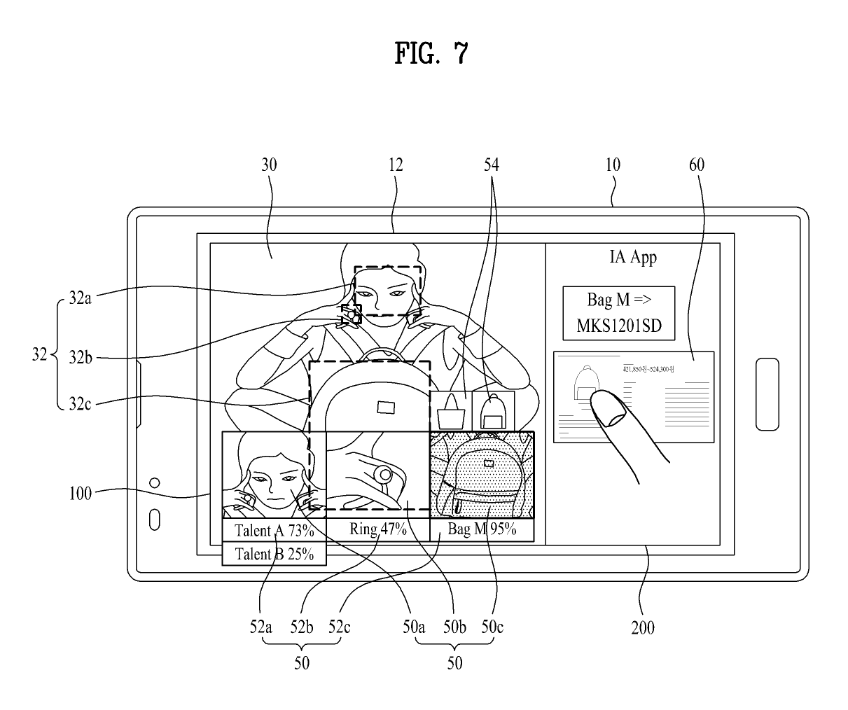

FIG. 7 shows a further embodiment of the present invention. Referring to FIG. 7, the IA application 200 may provide a derivative object interface 54 to allow the user to directly access a web search result that is additionally performed based on the search results 60 with respect to the respective image objects 32. For example, in the embodiment shown in FIG. 5, the user may receive the search result 60 of to the image object 32c (i.e. the keyword ‘Bag M’) via the IA application 200 by selecting the object interface 50c. In this case, the user may perform additional search based on the search result 60 of FIG. 5. That is, the user may further search a bag corresponding to a particular serial number among a plurality of bags searched with respect to the keyword ‘Bag M’. The additional search performed on the IA application 200 by the user as described above is referred to as search for a derivative image object, i.e. search for an image object derived from the initially searched image object 32c. In this case, the initially searched image object 32c may be a root image object of the derivative image object.

The IA application 200 according to the embodiment of the present invention may display the derivative object interface 54 on the first application 100, and the derivative object interface 54 serves to assist the user in directly accessing a search result with respect to the derivative image object. In this case, the IA application 200 may display the derivative object interface 54 on a peripheral region of the object interface 50c corresponding to the root image object 32c. If a plurality of derivative object interfaces 54 is derived from one root object interface 32c, the IA application 200 may display the plurality of derivative object interfaces 54 in a list form. Alternatively, the IA application 200 may display the plurality of derivative object interfaces 54 in a tree form based on the search history of the corresponding derivative image objects.

If a user input of selecting the derivative object interface 54 is received, the IA application 200 may provide a search result of a derivative image object corresponding to the selected derivative object interface 54. As such, when the user attempts to check the search result of the derivative image object later, the user can directly receive the search result of the corresponding derivative image object from the IA application 200 without performing search with respect to the root image object 32c.

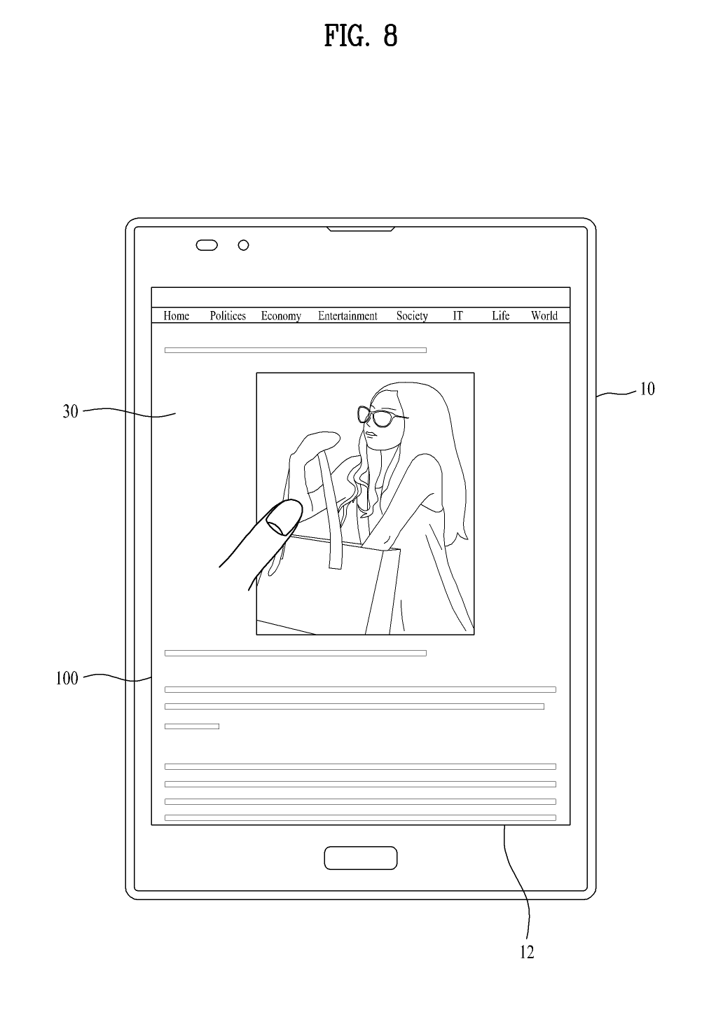

FIGS. 8 to 10 are views showing other embodiments for implementation of image search with respect to the image object 32 using the IA application 200 according to the present invention. In the embodiments shown in FIGS. 8 to 10, the first application 100 is a web browser. In the embodiments of FIGS. 8 to 10, a detailed description related to the same or corresponding configurations as those in the embodiments of FIGS. 5 to 7 will be omitted hereinafter.

FIG. 8 shows a executed state of the first application 100, i.e. of the web browser. The first application 100 may display a web page as the content 30 including image data on the display unit 12. The web page may include at least one image object. In FIG. 8, the IA application (not shown) of the present invention may be driven along with the web browser. According to the embodiment of the present invention, the user may perform a user input of selecting particular image data from the web page displayed by the web browser. The IA application extracts at least one image object from the selected image data.

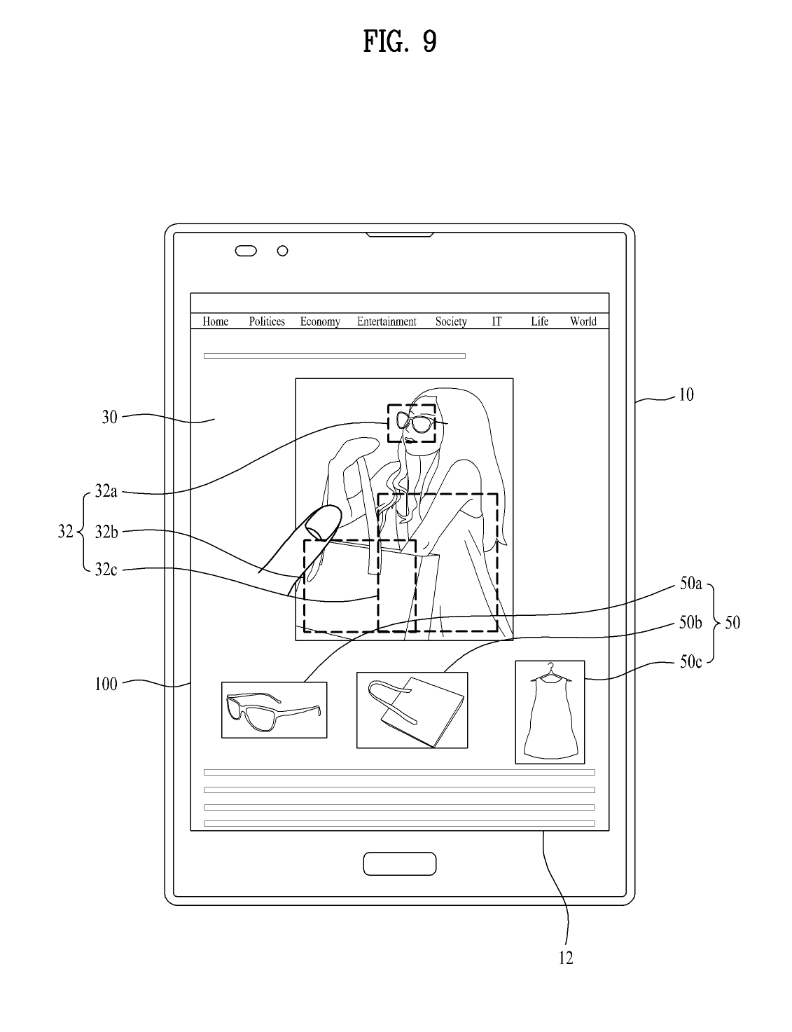

FIG. 9 shows a state in which the IA application provides the object interface 50 on the first application 100 when the corresponding first application 100 is a web browser according to the present invention. First, the IA application extracts at least one image object 32 from image data included in the web page displayed by the first application 100. Next, the IA application may insert the object interface 50 corresponding to each image object 32 into the corresponding web page. In the embodiment shown in FIG. 9, the IA application extracts the image objects 32a, 32b and 32c from image data, and provides the object interfaces 50a, 50b and 50c corresponding to the respective image objects on the first application 100. In the embodiment of the present invention, the IA application may display the object interface 50 on a region of the first application 100 corresponding to the image object 32, or on a preset region of the first application 100.

In the embodiment shown in FIG. 9, the IA application may analyze a layout of the corresponding web browser in order to display the object interface 50 on the first application 100. For example, the IA application may perform analysis of Hyper Text Markup Language (HTML) with respect to the corresponding web browser. Alternatively, the IA application may perform layout analysis with respect to a current display region of the web page provided by the web browser. When analyzing the layout of the web browser as described above, the IA application analyzes an inserted position of the object interface 50. Next, the IA application inserts the object interface 50 into the web browser via correction of an original HTML of the web browser. In this case, the IA application may insert link information corresponding to each object interface 50.

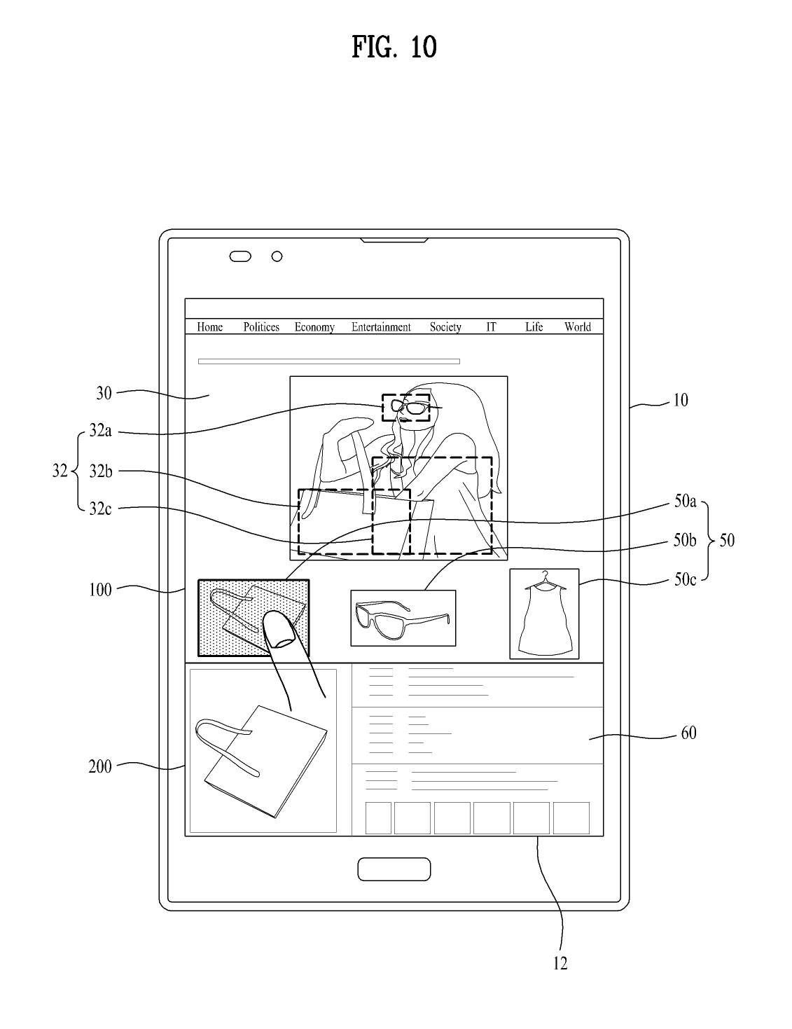

Next, referring to FIG. 10, the IA application 200 may receive a user input of selecting a particular object interface among one or more object interfaces 50 provided on the first application 100. For example, as shown in FIG. 10, if the object interface 50a is selected, the IA application 200 may perform image search with respect to the image object 32a corresponding to the object interface 50a. After search with respect to the image object 32a is completed, the IA application 200 may display the search result 60 of the image object 32a. In this case, the IA application 200 may provide the search result 60 within the display region of the IA application 200. In the embodiment shown in FIG. 10, a detailed description related to reception of a user input, implementation of image search, and provision of the search result 200 is equal to the above description with reference to FIG. 5.

In the embodiments shown in FIGS. 2 to 10, a basic operation of each of the first application 100 and the IA application 200 may be performed in the same manner as a traditional manner. That is, even after the IA application 200 provides at least one object interface 50 on the first application 100, the first application 100 may continuously provide the same function. For example, if the first application 100 is a video player, the first application 100 may continuously provide the video playback function of the video player. Also, if the first application 100 is a web browser, the first application 100 may provide the function of the web browser, such as web browsing or scrolling of a web page, for example.

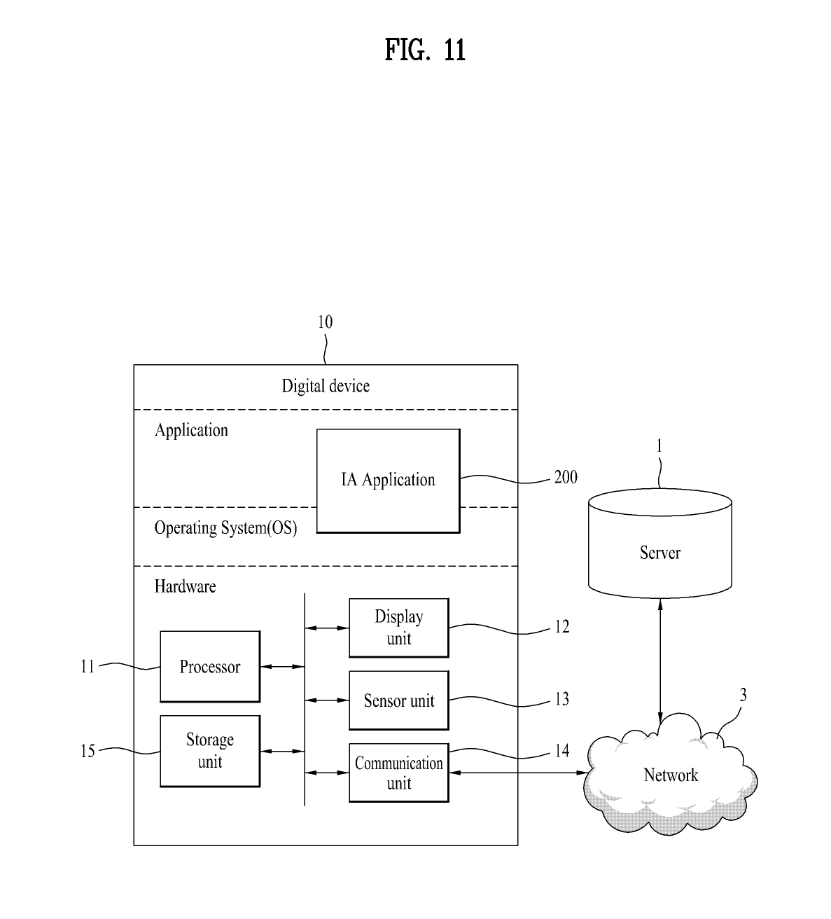

FIG. 11 is a block diagram showing the digital device 10 according to an embodiment of the present invention.

Referring to FIG. 11, the digital device 10 of the present invention may include a hardware class, an Operating System (OS) class, and an application class.

First, the hardware class of the digital device 10 may include a processor 11, the display unit 12, a sensor unit 13, a communication unit 14 and a storage unit 15.

First, the display unit 12 outputs an image on a display screen. The display unit 12 may output an image based on content executed in the processor 11 or a control command of the processor 11. In the embodiment of the present invention, the display unit 12 may display the first application and the IA application 200, which are executed by the digital device 10.

The sensor unit 13 may recognize a user input using at least one sensor mounted to the digital device 10 according to the present invention, and may transmit the user input to the processor 11. In this case, the sensor unit 13 may include at least one sensing means. In an embodiment, the at least one sensing means may include a gravity sensor, geomagnetic sensor, motion sensor, gyro sensor, accelerometer, infrared sensor, inclination sensor, brightness sensor, height sensor, olfactory sensor, temperature sensor, depth sensor, pressure sensor, bending sensor, audio sensor, video sensor, Global Positioning System (GPS), and touch sensor, for example. The sensor unit 13 is a generic term for the above described various sensing means, and may sense a variety of user inputs and user environments and may transmit the sensed result to the processor 11 so as to allow the processor 11 to implement an operation based on the sensed result. The aforementioned sensors may be provided as individual elements included in the digital device 10, or may be combined to constitute at least one element.

Next, the communication unit 14 may perform transmission/reception of data by communicating with an external device or a server 1 using a variety of protocols. In the present invention, the communication unit 14 may be connected to the server 1 via a network to enable transmission/reception of digital data. For example, the communication unit 14 may transmit an image object to the server 1, and receive a search keyword corresponding to the image object from the server 1. Also, the communication unit 14 may transmit a search keyword to the server 1, and receive a search result corresponding to the search keyword from the server 1.

Next, the storage unit 15 of the present invention may store various digital data, such as video and audio data, pictures, applications, and the like. The storage unit 15 represents various digital data storage spaces, such as a flash memory, Random Access Memory (RAM), and Solid State Drive (SSD), for example. In the embodiment of the present invention, the storage unit 15 may store data generated by the IA application 200. Also, the storage unit 15 may temporarily store data transmitted from the server 1 to the communication unit 14.

The processor 11 of the present invention may execute content received via data communication, or content stored in the storage unit 16, for example. Also, the processor 11 may execute various applications and process internal data of the digital device 10. In the embodiment of the present invention, the processor 11 may execute the first application 100 and the IA application 200, and perform an operation based on a control command of each application. In addition, the processor 11 may control the aforementioned respective units of the digital device 10, and control transmission/reception of data between the units.

Next, the OS class of the digital device 10 may include an OS to control the respective units of the digital device 10. The OS may assist the applications of the digital device 10 in controlling and using the respective units of the hardware class. The OS serves to efficiently distribute resources of the digital device 10 and prepare implementation environments of the respective applications. The application class of the digital device 10 may include one or more applications. The applications include various kinds of programs to enable implementation of particular operations. The applications may use the resources of the hardware class under assistance of the OS.

According to the embodiment of the present invention, the IA application 200 may be included in the OS class or the application class of the digital device 10. That is, the IA application 200 may be software embedded in the OS class or software included in the application class of the digital device 10.

In FIG. 11 showing the digital device 10 according to the embodiment of the present invention in the block diagram, the individual blocks represent logically divided elements of the digital device 10. Thus, the aforementioned elements of the digital device 10 may be mounted in a single chip or in a plurality of chips according to a device design.

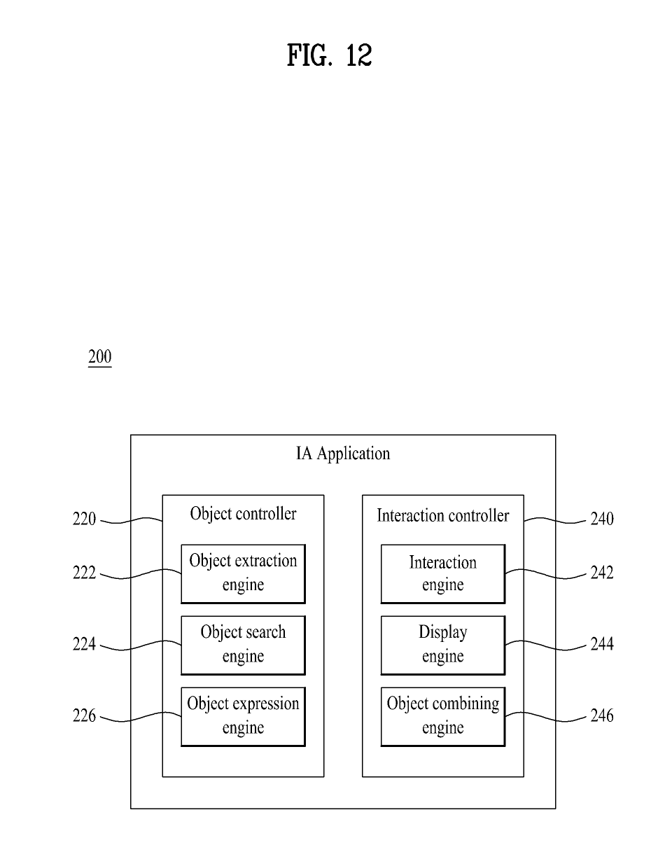

FIG. 12 is a block diagram showing a configuration of the IA application 200 according to an embodiment of the present invention. As shown in FIG. 12, the IA application 200 may include an object controller 220 and an interaction controller 240.

First, the object controller 220 serves to extract an image object from image data and provide an object interface. The object controller 220 may include an object extraction engine 222, an object search engine 224, and an object expression engine 226. The object extraction engine 222 extracts at least one image object from content displayed by the first application. The object search engine 224 generates a search keyword with respect to the at least one extracted image object. Additionally, the object search engine 224 may perform search with respect to the corresponding image object and acquire an associated search result. According to the embodiment of the present invention, the object search engine 224 may acquire information on the search keyword and the search result from the server. The object expression engine 226 expresses the object interface, the search keyword, and the reliability of the search keyword, for example, on the first application. For example, the object expression engine 226 expresses the object interface using a preset method or rule.

Next, the interaction controller 240 takes charge of interaction between the IA application 200 and the first application. The interaction controller 240 may include an interaction engine 242, a display engine 244, and an object combining engine 246. The interaction engine 242 controls interaction between the IA application 200 of the present invention and the first application. That is, the interaction engine 242 controls transmission/reception of data between the IA application 200 and the first application. Thus, the interaction engine 242 allows the IA application 200 of the present invention to operate in conjunction with the first application. The display engine 244 controls the display region of the IA application 200 on the display unit of the digital device. More specifically, the display engine 244 adjusts the size and position of the display region of the IA application 200, and controls display of the IA application 200 on the display unit using, for example, an Augmented Reality (AR) pop-up window. In the case of a user input of selecting a plurality of image objects, the object combining engine 246 analyzes correlation of the plurality of image objects in response to the user input, and generates a meaningful combination of the image objects. The object combining engine 246 may also combine search keywords corresponding respectively to the plurality of image objects in various ways.

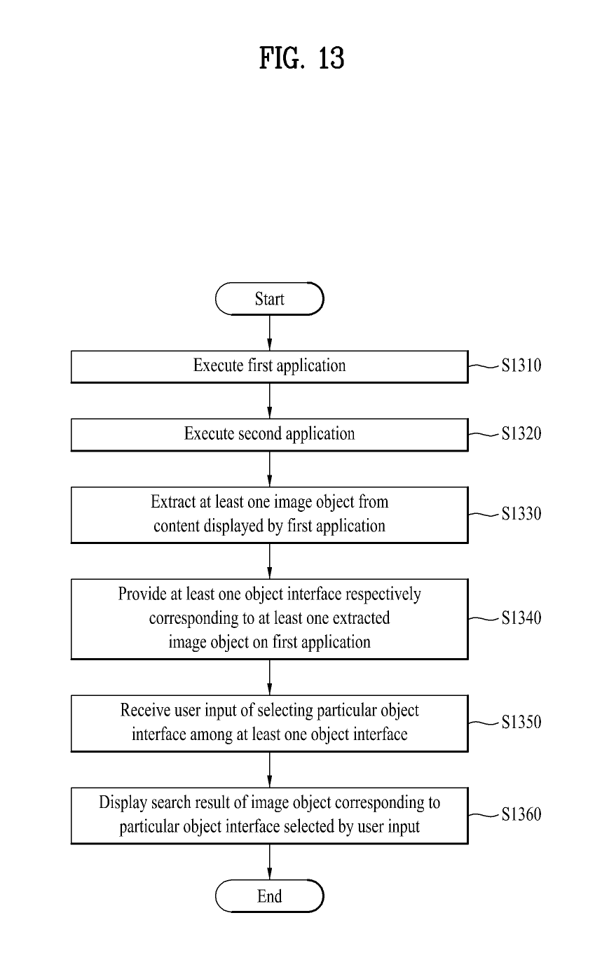

FIG. 13 is a flowchart showing an image search method according to one embodiment of the present invention. In the present invention, the processor 11 of the digital device 10 shown in FIG. 11 may control respective operations of FIG. 13 that will be described hereinafter.

First, the digital device of the present invention may execute a first application (S1310). The first application displays content including at least one image object. In the present invention, the first application includes various applications to allow image data included in content to be output on the display unit of the digital device.

Next, the digital device of the present invention may execute a second application (S1320). The second application provides an image search result of the at least one image object included in the content displayed by the first application. In the embodiment of the present invention, the second application may be an IA application. As described above with reference to FIG. 2, the digital device may simultaneously activate the second application and the first application. Alternatively, the digital device may display the second application along with the first application such that the second application is displayed adjacent to at least one side of the first application.

Next, the digital device of the present invention extracts at least one image object from the content displayed by the first application (S1330). In this case, the digital device extracts the at least one image object via the second application of the present invention. That is, the digital device may extract the at least one image object from the content displayed by the first application using a command provided by the second application. The second application of the present invention may analyze an image displayed on the first application via image processing, and extract the at least one image object from the analyzed image.

Next, the digital device of the present invention provides, on top of the first application, at least one object interface corresponding to the respective extracted image object (S1340). In this case, the digital device may provide, on top of the first application, the at least one object interface via the second application of the present invention. The second application of the present invention may provide the at least one object interface on a region of the first application corresponding to the respective image object. For example, the second application may provide, on top of the first application, the at least one object interface overlaid on the corresponding image object. Alternatively, the second application may display the at least one object interface on a preset region of the first application. Meanwhile, according to the embodiment of the present invention, the second application may provide only the image object, the keyword of which has been generated, among one or more image objects included in the content, with the object interface. A detailed description related to Operation S1340 according to the present invention is equal to the above description with reference to FIGS. 3(a) and 3(b) and FIGS. 4 and 9.

Next, the digital device of the present invention receives a user input of selecting a particular object interface among one or more object interfaces (S1350). In this case, the user input of selecting the particular object interface may be a touch input on the particular object interface, and an input of dragging the particular object interface and dropping the same on the display region of the second application, for example, although the present invention is not limited thereto.

Next, the digital device of the present invention displays the search result of the image object corresponding to the particular object interface selected by the user input (S1360). To this end, the second application performs image search with respect to the image object corresponding to the particular object interface. Once the second application has acquired the image search result, the digital device may provide the search result within the display region of the second application. However, the present invention is not limited to the above description, and the digital device may display the search result on the display region of the first application or on a preset region of the display unit. Detailed descriptions related to Operations S1350 and S1360 according to the present invention are equal to the above description with reference to FIGS. 5 and 10.

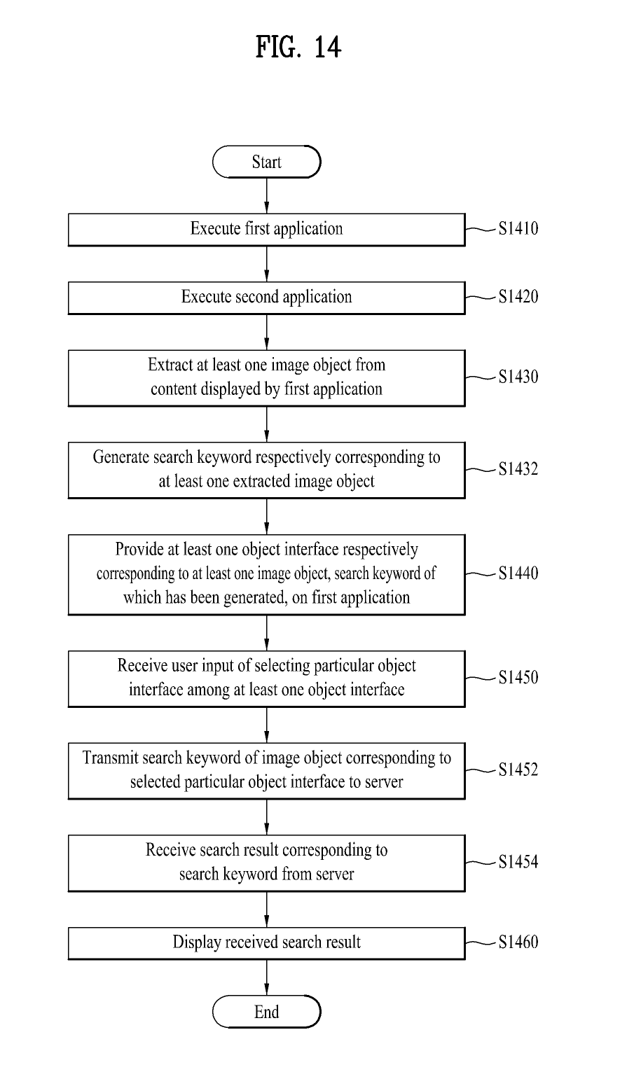

FIG. 14 is a flowchart showing an image search method according to another embodiment of the present invention. In the present invention, the processor 11 of the digital device 10 shown in FIG. 11 may control respective operations of FIG. 14. In the embodiment shown in FIG. 14, a detailed description related to the same or corresponding configurations as those in the above-described embodiment of FIG. 13 will be omitted hereinafter.

First, the digital device of the present invention executes a first application and a second application (S1410 and S1420). Next, the digital device of the present invention extracts at least one image object from content displayed by the first application (S1430). Detailed descriptions related to Operations S1410 and S1430 according to the present invention are equal respectively to the above descriptions of Operations S1310 and S1330 of FIG. 13.

Next, the digital device of the present invention generates a search keyword respectively corresponding to the at least one extracted image object (S1432). The search keyword may be a text form keyword to search information corresponding to the respective image object. In this case, the digital device may generate the search keyword via the second application of the present invention. According to one embodiment of the present invention, the second application may utilize the database embedded in the digital device for generation of the search keyword. On the other hand, according to another embodiment of the present invention, the second application may acquire the search keyword corresponding to the image object using an external server. That is, the second application may transmit the at least one extracted image object to the server, and receive the search keyword corresponding to the at least one image object from the server.

Next, the digital device of the present invention provides, on top of the first application, at least one object interface corresponding to the at least one image object, the search keyword of which has been generated (S1440). In this case, the digital device may provide the object interface via the second application of the present invention. According to one embodiment of the present invention, the second application may provide the object interface corresponding to each image object, which has succeeded in generating the search keyword, among all the extracted image objects, on the first application. On the other hand, according to another embodiment of the present invention, the second application may provide the object interface corresponding to the image object, the reliability of the keyword of which exceeds a preset critical value, among all the extracted image objects. Also, as described above in relation to the embodiment shown in FIG. 4, the digital device may display the generated search keyword corresponding to each image object and the object interface together on the display region of the first application. In addition, the digital device may display the reliability of the search keyword and the search keyword together.

Next, the digital device of the present invention receives a user input of selecting a particular object interface among one or more object interfaces (S1450). Once the particular object interface has been selected by the user input, the digital device transmits the search keyword of the image object corresponding to the selected particular object interface to the server (S1452). In this case, the server may perform search with respect to the received search keyword, and generate a search result. Next, the digital device receives the search result corresponding to the search keyword from the server (S1454).

Next, the digital device of the present invention displays the received search result (S1460). A detailed description related to display of the search result is equal to the above description of Operation S1360 of FIG. 13.

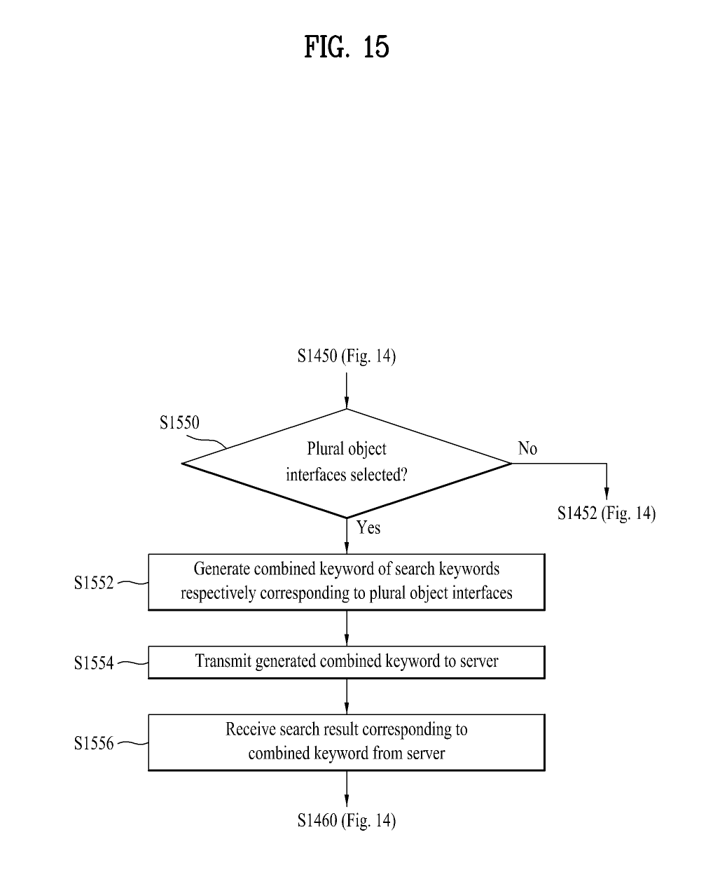

FIG. 15 is a flowchart showing an image search method according to a further embodiment of the present invention. FIG. 15 shows the case in which a user input of selecting a plurality of object interfaces is received according to the embodiment of the present invention.

First, if the user input of selecting the particular object is received in Operation S1450, the digital device determines whether or not a plurality of object interfaces is selected (S1550). If the plurality of object interfaces is not selected, the digital device may perform Operation S1452 of FIG. 14.

If the plurality of object interfaces is selected, the digital device generates a combined keyword by combining search keywords corresponding respectively to the plurality of object interfaces (S1552). The combined keyword is a combination of the plurality of search keywords, and various method for combining the plurality of search keywords are known. In this case, the digital device may generate the combined keyword via the second application of the present invention.

Next, the digital device transmits the combined keyword to the server (S1554). The server may perform search with respect to the received combined keyword, and generate a search result. Next, the digital device receives the search result corresponding to the combined search keyword from the server (S1556). Next, the digital device of the present invention returns to Operation S1460 of FIG. 14, to display the received search result. A detailed description related to each operation of FIG. 15 is equal to the above description with reference to FIG. 6.

As is apparent from the above description, with an image search method according to an embodiment of the present invention, it is possible to provide an intuitive and simple user interface capable of assisting a user in selecting an image object for image search, and to provide image search results with respect to the selected image object via the user interface.

In particular, according to an embodiment of the present invention, a second application can provide an object interface, which is capable of extracting a plurality of image objects from content displayed by a first application and selecting any one of the image objects. In this way, according to the embodiment of the present invention, even if the first application does not provide a separate interface for selection of each image object, the user can select an image object for search using the object interface provided by the second application.

According to an alternative embodiment of the present invention, the user can select a plurality of image objects from content displayed by the first application, and receive search results of combinations of a plurality of selected image objects.

According to an embodiment of the present invention, it is possible to previously instruct a searchable image object from content displayed by the first application, thereby eliminating inconvenience caused when searching an image object, search results of which cannot be provided.

According to an embodiment of the present invention, it is possible to provide search results of an image object displayed by the first application in an activated state of the first application. Accordingly, the user can confirm the search results of the corresponding image object in a state in which the first application can be continuously used.

In this way, the present invention provides a variety of simple user interfaces for image object based search.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An image search method comprising:
executing a first application, wherein the first application displays content including at least one image object;
executing a second application, wherein the second application provides an image search result of the image object included in the content displayed by the first application;
extracting the at least one image object from the content displayed on the first application via the second application;
providing, on top of the first application, at least one object interface respectively corresponding to the at least one extracted image object via the second application;
receiving a user input of selecting a particular object interface among the at least one object interface; and
displaying a search result of the image object corresponding to the particular object interface selected by the user input.

2. The image search method according to claim 1, wherein the first application and the second application are simultaneously in activated statuses.

3. The image search method according to claim 2, wherein the first application and the second application are displayed together, and the second application is displayed on a region adjacent to at least one side of the first application.

4. The image search method according to claim 1, wherein the providing the at least one object interface includes activating the object interface on a region corresponding to the associated image object.

5. The image search method according to claim 4, wherein the providing the at least one object interface includes providing the object interface overlaid on the corresponding image object on the first application.

6. The image search method according to claim 1, further comprising generating a search keyword respectively corresponding to the at least one extracted image object via the second application,
wherein the providing the at least one object interface includes providing, on top of the first application, the at least one object interface corresponding to the at least one image object, the search keyword of which has been generated.

7. The image search method according to claim 6, wherein the generating the search keyword includes:
transmitting the at least one extracted image object to a server; and
receiving the search keyword corresponding to the at least one extracted image object from the server.

8. The image search method according to claim 6,
wherein the providing the at least one object interface further includes displaying the generated search keyword on a region of the first application corresponding to the object interface, and
wherein display properties of the search keyword are adjusted by the second application.

9. The image search method according to claim 8,
wherein the providing the at least one object interface further includes displaying the reliability of the search keyword corresponding to the associated image object, and
wherein the reliability indicates a matching rate between the search keyword and the associated image object.

10. The image search method according to claim 6, further comprising:
transmitting the search keyword of the image object corresponding to the particular object interface selected by the user input to a server; and
receiving a search result corresponding to the search keyword from the server,
wherein the displaying the search result includes displaying the received search result.

11. The image search method according to claim 1,
wherein the receiving the user input includes receiving a user input of selecting a plurality of object interfaces, and
wherein the displaying the search result includes displaying a combined search result of image objects respectively corresponding to the plurality of object interfaces.

12. The image search method according to claim 11, further comprising:
generating a combined keyword of search keywords respectively corresponding to the plurality of object interfaces selected by the user input;
transmitting the generated combined keyword to a server; and
receiving a search result corresponding to the combined keyword from the server,
wherein the displaying the search result includes displaying the received search result.

13. A digital device comprising:
a processor configured to control an operation of the digital device;
a communication unit configured to perform transmission/reception of data with a server based on a command of the processor; and
a display unit configured to output an image based on a command of the processor,
wherein the processor performs the following operations including:
executing a first application, wherein the first application displays content including at least one image object;
executing a second application, wherein the second application provides an image search result of the image object included in the content displayed by the first application;
extracting the at least one image object from the content displayed on the first application via the second application;
providing, on top of the first application, at least one object interface respectively corresponding to the at least one extracted image object via the second application;
receiving a user input of selecting a particular object interface among the at least one object interface; and
displaying a search result of the image object, corresponding to the particular object interface selected by the user input, on a display unit.

14. The digital device according to claim 13, wherein the first application and the second application are simultaneously in activated statuses.

15. The digital device according to claim 14, wherein the processor displays the first application and the second application together such that the second application is displayed on a region adjacent to at least one side of the first application.

16. The digital device according to claim 13, wherein the processor activates the object interface on a region corresponding to the associated image object.

17. The digital device according to claim 16, wherein the processor causes the object interface to be overlaid on the corresponding image object on the first application.

18. The digital device according to claim 13, wherein the processor generates a search keyword respectively corresponding to the at least one extracted image object via the second application, and provides, on top of the first application, the at least one object interface corresponding to the at least one image object, the search keyword of which has been generated.

19. The digital device according to claim 18, wherein the processor transmits the at least one extracted image object to a server, and receives the search keyword corresponding to the at least one extracted image object from the server.

20. The digital device according to claim 18,
wherein the processor displays the generated search keyword on a region of the first application corresponding to the associated object interface, and
wherein display properties of the search keyword are adjusted by the second application.

21. The digital device according to claim 20,
wherein the processor displays the reliability of the search keyword corresponding to the associated image object, and
wherein the reliability indicates a matching rate between the search keyword and the associated image object.

22. The digital device according to claim 18, wherein the processor transmits the search keyword of the image object corresponding to the particular object interface selected by the user input to a server, receives a search result corresponding to the search keyword from the server, and displays the received search result.

23. The digital device according to claim 13, wherein the processor receives a user input of selecting a plurality of object interfaces, and displays a combined search result of image objects respectively corresponding to the plurality of object interfaces.

24. The digital device according to claim 23, wherein the processor generates a combined keyword of search keywords respectively corresponding to the plurality of object interfaces selected by the user input, transmits the generated combined keyword to a server, receives a search result corresponding to the combined keyword from the server, and displays the received search result.
